(19) United States
(12) Patent Application Publication
(10) Pub. No.: US 2014/0262436 A1
(43) Pub. Date: Sep. 18, 2014

(54) Electrical Equipment Clip

(71) Applicants: Gene Brazel, Toledo, OR (US); Dev Brazel, Albany, OR (US)

(72) Inventors: Gene Brazel, Toledo, OR (US); Dev Brazel, Albany, OR (US)

(21) Appl. No.: 14/203,228

(22) Filed: Mar. 10, 2014

Related U.S. Application Data
(60) Provisional application No. 61/802,817, filed on Mar. 18, 2013.

(51) Int. Cl. B25J 15/00

(52) U.S. Cl. CPC B25J 15/0038
USPC 174/135

(57) ABSTRACT

An electrical equipment clip for use with electrical cables is provided herein. Embodiments include clips in a plurality of sizes for attaching to electrical cables, deadbreak elbows, and loadbreak elbows. The electrical equipment clip has markings on detachably attached information tabs that allow linesmen to quickly and easily determine the electrical characteristics of the cable to which the electrical equipment clip is affixed. The electrical equipment clip can be used by linemen to manipulate electrical cables by using a grip-all without the need to first de-energize the cables. The present invention meets compliance requirements and reduces the cost and manpower required to manipulate electrical cables while simultaneously reducing the risk of accident or injury.

### CROSS-REFERENCES TO RELATED APPLICATIONS

This application claims priority to U.S. Provisional Patent Application Ser. No. 61/802,817 filed on Mar. 18, 2013 entitled “Electrical Cable Clip”, the disclosure of which is hereby incorporated by reference.

### BACKGROUND OF THE INVENTION

1. Field of the Invention

The present invention relates to electrical infrastructure, and, more specifically, to a device that allows for the identification and safe and secure handling of electrical equipment.

2. Description of the Related Art

The use of cable identification devices is well known within the art. Before conducting repairs or modifications to existing electrical transformers or associated secondary electrical cabling, electrical linemen must first identify the desired equipment to be worked upon. Generally, a linemen must determine which particular cables, amongst a plurality of secondary cables in a transformer, lead to the meter base of a given building or structure, as well as any particular cables, amongst a plurality of secondary cables uncovered or unearthed in a dug pit, lead to the meter base of a building or structure, or which desired cable is to be spliced.

To accomplish such cable identification, linemen are typically required to systematically detach secondary cables from a given transformer to determine which building or structure the secondary cables supply power to. Such a determination is made upon detecting a cessation of electrical current to a particular building structure. A method such as this bears obvious consequences, as several building dwellers will experience a brief power outage until the desired cables and associated building or structure is identified, thus causing potentially damaging cessations in business operations, loss of unsaved computer documentation, or general household inconvenience.

Additionally, although terminal ends of primary cables leading from one transformer to another transformer are identifiable, it can be difficult to identify the specific phases of primary cables which have been unearthed or exposed in a dug pit, wherein such identification is determined for purposes of splicing in an additional transformer to service new secondary users.

Electrical identification equipment is known within the art. Equipment available for identification of primary and secondary cables lends itself to be very large, heavy and bulky, overly complex to implement, as well as extremely expensive. As such, these devices are rarely utilized by linemen, and may not be issued as standard equipment to linemen by their electrical servicing company. Additionally, the overall bulky or cumbersome nature of such equipment makes the deployment or implementation burdensomely difficult. This difficulty can be amplified by the close proximity of secondary cables. Moreover, carrying such weighty equipment into and out of dug pits or ditches is undoubtedly a physically strenuous task, and poses significant risk if dropped onto live cables or other linemen.

It is also possible to identify buried cables by applying a specific electric frequency to the cable, and then detecting the magnetic fields generated by that signal from the surface. As such, this removes the need for excavation, since the frequencies of the signal are chosen so that the magnetic fields generated will be detectable at surface level.

Unfortunately, such a frequency may be transferred to other cables by induction and capacitive leakage. This generally leads to distorted magnetic fields, resulting in mis-location of the cable, or even the possibility of the wrong cable being identified.

Another such identification method sees removable tags applied to cables. These tags can often be difficult to read, especially within the low-light confines of a dug pit.

Furthermore, electrical cable tagging systems found within the prior art do not provide a means for a lineman to manipulate the electrical cable. A separate means to attach, detach, or otherwise manipulate an electrical cable must be used aside from any indicator tagging systems found on the cable. The present invention overcomes this deficiency by providing a combination tagging system and means for manipulating an electrical cable.

In addition, as well as providing for the identification and manipulation of electrical cables, the present invention can be used to manipulate deadbreak or loadbreak elbows without causing any interference with normal operations. The prior art does not provide any solution that allows a lineman to attach a device to a deadbreak or loadbreak elbow that can be used to manipulate the deadbreak or loadbreak elbow and does not interfere with the normal operations of the deadbreak or loadbreak elbow.

Therefore, it is readily apparent that there lies a need for an apparatus and method for electrical cable identification that is expeditious, inexpensive, lightweight, personally portable, electrically benign, easily readable in lower-light conditions, and easy to implement, wherein both primary and secondary cables, including grounded secondary cables/conductors, may be identified without the aforementioned disadvantages.

The present invention meets these needs by supplying the user with a small, easily-identifiable in any light condition, preset of cable characteristics which clips upon the cable without the need of supportive equipment that allows linemen to manipulate the electrical equipment to which the clip is attached.

### BRIEF SUMMARY OF THE INVENTION

The present invention provides a clip apparatus that can be detachably attached to electrical equipment so that the equipment can be manipulated without the need for de-energization. Attachment to the electrical equipment is accomplished by way of flexible, yet rigid flanges that wrap partially around the equipment. Embodiments have markings to indicate electrical information such as line voltage, phase identification, and line identification. The present invention can be used by linemen and others for safely manipulating electrical equipment without having to first de-energize the line. The present invention allows an electrical cable to be manipulated by a single person using a grip-all, or shotgun stick manipulation tool.

In one preferred embodiment of the present invention, an electrical equipment clip is provided with markings that indicate necessary information about an electrical cable to which it is attached. This preferred embodiment also has an attachment for manipulating the electrical cable via a shotgun stick and an attachment for securing lanyards or identification tabs. The lanyard attachment can be used to secure destination or GPS tags to the electrical equipment to which the invention is attached. The embodiment has detachable tags that indicate line voltage and phase information. The tags can be detached so that the remaining tags properly indicate the electrical characteristics and identification of the cable to which the electrical equipment clip is attached. The embodiment is made of a highly visible oil and heat resistant polymer.

Another embodiment of the present invention is provided for use with deadbreak and loadbreak elbows. This embodiment securely fits over deadbreak and loadbreak elbows and has a shotgun stick ring so that the deadbreak or loadbreak elbows can be safely manipulated without de-energization. A forward baffle covers a deadbreak bail assembly. A capacitor test point opening allows users to test capacitors without removing the invention. This embodiment is made of a heat and oil resistant polymer that is highly visible, reflective, and luminescent.

The preceding brief description is intended to merely outline some functions and advantages of the present invention. The following disclosure will set forth other functions and advantages of the present invention along with novel features that distinguish the present invention from the prior art. It is to be understood that the following disclosure is by no means intended to limit the scope of the present invention or any of its embodiments. It is also to be understood that the accompanying illustrations are presented for descriptive purposes only and similarly are not intended to limit the scope of present invention or any of its embodiments. The following disclosure and accompanying illustrations may describe various features of novelty that characterize the invention. The invention does not reside any particular feature when taken in the singular, but in the combination of features as described herein.

### BRIEF DESCRIPTION OF THE SEVERAL VIEWS OF THE DRAWING

FIG. 1 is a front perspective view of an exemplary electrical cable clip as according to one embodiment of the present invention;

FIG. 2 is a rear perspective view of an exemplary electrical cable clip as according to one embodiment of the present invention;

FIG. 3 is a side elevation view of an exemplary electrical cable clip as according to one embodiment of the present invention;

FIG. 4 is a front end elevation view of an exemplary electrical cable clip as according to one embodiment of the present invention;

FIG. 5 is a rear end elevation view of an exemplary electrical cable clip as according to one embodiment of the present invention;

FIG. 6 is a detailed front end elevation view of an exemplary electrical cable clip as according to one embodiment of the present invention;

FIG. 7 is a detailed rear end elevation view of an exemplary electrical cable clip as according to one embodiment of the present invention;

FIG. 8 is cross-sectional view of an exemplary electrical cable clip as according to one embodiment of the present invention;

FIG. 9 is a front perspective view of an exemplary deadbreak or loadbreak elbow clip as according to one embodiment of the present invention;

FIG. 10 is a rear perspective view of an exemplary deadbreak or loadbreak elbow clip as according to one embodiment of the present invention;

FIG. 11 is a front elevation view of an exemplary deadbreak or loadbreak elbow clip as according to one embodiment of the present invention;

FIG. 12 is a side cross-sectional view of an exemplary deadbreak or loadbreak elbow clip as according to one embodiment of the present invention;

FIG. 13 is a detailed front end cross-sectional view of an exemplary deadbreak or loadbreak elbow clip as according to one embodiment of the present invention;

FIG. 14 is a rear end cross-sectional view of an exemplary deadbreak or loadbreak elbow clip as according to one embodiment of the present invention;

FIG. 15 is a rear elevation view of an exemplary deadbreak or loadbreak elbow clip as according to one embodiment of the present invention; and

FIG. 16 is a front end cross-sectional view of an exemplary deadbreak or loadbreak elbow clip as according to one embodiment of the present invention.

A further understanding of the present invention can be obtained by reference to a preferred embodiment set forth in the accompanying description. Although the illustrated embodiments are merely exemplary of apparatus for carrying out the present invention, both the organization and construction of the invention, in general, together with further objectives and advantages thereof, may be more easily understood by reference to the illustrations and the following description. The figures are not intended to limit the scope of this invention, but merely to clarify and exemplify the invention.

Certain figures contain labels, measurements, or other alphanumeric indicators. None of the aforementioned are intended to limit the scope of the invention, but are included merely to clarify and exemplify the invention.

### DETAILED DESCRIPTION OF THE INVENTION

In the following detailed description, reference is made to the accompanying images that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by appended claims, appropriately interpreted, along with the full range of equivalents to which the claims are entitled.

Further, the purpose of the Abstract of the Disclosure herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application nor is it intended to be limiting as to the scope of the invention in any way.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the apparatus include the discussed feature, advantage or mode of operation. The following descriptions of the preferred embodiments are merely exemplary in nature and is in no way intended to limit the invention, its application, or use.

For the purpose of clarity, all like elements will have the same numbering and designations in each of the images. The terms “electrical equipment clip”, “electrical cable clip”, “cable clip”, “deadbreak elbow clip”, “loadbreak elbow clip”, “elbow clip”, “clip”, “present invention”, and “invention” may be used interchangeably. In addition to the functions, features, components, and abilities of the apparatus already discussed in this specification, the present invention may also have, but not be limited to, the following features contained within the description set forth herein.

Several preferred embodiments of the electrical equipment clip are discussed in this section. However, the invention is not limited to these embodiments. An electrical equipment clip, as according to the present invention, is any clip that can be detachably attached to electrical equipment, such as an electrical cable, a deadbreak elbow, or a loadbreak elbow, so that the equipment may be safely manipulated without the need for de-energizing the equipment.

Referring now to FIGS. 1-8, that will be discussed together, there is illustrated an embodiment of the electrical equipment clip that is designed to attach to electrical cables. This embodiment has an electrical equipment clip body (100) that wraps partially around an electrical cable. Shaped flanges (101) attached to the equipment clip body (100) detachably secure the electrical equipment clip to the electrical cable. The shaped flanges (101) are rigid enough to sufficiently grip the electrical cable so that the electrical equipment clip remains firmly in place and does not inadvertently move when the electrical equipment clip is used to manipulate the electrical cable. The shaped flanges (101) can be broken off of the electrical equipment clip so that the clip can be removed from electrical cables. The flanges (101) are constructed from a plastic polymer material that facilitates easy breakage and removal when necessary.

This embodiment also comprises a shotgun stick ring (103) for connection to a manipulation device such as a shotgun stick or a grip-all. Shotgun sticks and grip-alls are versatile tools commonly used by electrical linemen to safely work with energized equipment due to their insulating ability. The shotgun stick ring (103) is a roughly circular area of the body of sufficient strength to allow a shotgun stick or grip-all to attach to the electrical cable clip. A lineman can pick up, move, attach, detach, or perform other types of manipulation by using the shotgun stick ring (103) on the electrical equipment clip without having to de-energize the electrical cable to which the clip is attached. Furthermore, the shotgun stick ring (103) allows for the electrical cable to be manipulated with fewer people. Typical line-manipulation operations can require up to four individuals but with the present invention, it is possible for a single person to perform a manipulation procedure.

The present invention also comprises a lanyard ring (104) that can be used to attach identification devices or lanyards to the electrical equipment clip. Some identification devices are required to be attached to electrical cables for compliance purposes. The lanyard ring (104) provides a connection point on the body of the electrical equipment clip (100) for compliance-required identification devices, and other information devices such as destination tagging and GPS tagging devices. These identification devices are used to properly identify the electrical cable to which the electrical equipment clip is attached.

Detachable information tabs (102, 105) are provided to readily convey information about the electrical cable to which the clip is attached. Some of the detachable information tabs are phase identification tabs (102) that provide information about the phase of an electrical cable, while other detachable information tabs are voltage identification tabs (105) that provide information about the voltage of an electrical cable. The phase information displayed on the phase identification tabs (102) are displayed as whole numbers. The voltage information displayed on the voltage identification tabs (105) are displayed in units of volts, kilovolts, or megavolts. Certain embodiments of the present invention have information tabs that convey additional information related to electrical cables other than phase and voltage.

The detachable information tabs (102, 105) are initially attached to the electrical equipment clip but are later detached to leave only the tags that convey the correct information about a particular electrical cable. In an example of use, an embodiment of the present invention has detachable information tabs (102, 105) indicating phases of 1, 2, or 3, and kilovolt ratings of 12 or 21. When attached to an electrical cable of phase 1 and 12 kilovolts, the phase information tabs (102) 2 and 3 and the kilovolt information tab (105) 21 are detached. The remaining information tabs (102, 105) properly indicate that the electrical cable to which the electrical equipment clip is attached has a phase of 1 and a voltage of 12 kilovolts.

Other embodiments of the present invention have voltage identification tabs (105) of 34.5 kV and 4 kV while still other embodiments of the present invention have voltage information tabs (105) of 14.4 kV and 5 kV.

Referring now to FIGS. 9-16, that will be discussed together, there is illustrated an embodiment of the electrical equipment clip that is designed to attach to loadbreak and deadbreak elbows. Loadbreak and deadbreak elbows, generally, are a separable connector used for terminating and connecting an insulated electrical cable to some form of electrical equipment or other electrical cables.

This embodiment has an electrical equipment clip body (100) that securely fits over a loadbreak or deadbreak elbow by partially wrapping around the deadbreak or loadbreak elbow. Shaped flanges (101) attached to the equipment clip body (100) detachably secure the electrical equipment clip to the deadbreak or loadbreak elbow. The shaped flanges (101) are rigid enough to sufficiently grip the deadbreak or loadbreak elbow so that the electrical equipment clip remains firmly in place and does not inadvertently move when the electrical equipment clip is used to manipulate the deadbreak or loadbreak elbow. The shaped flanges (101) can be broken off of the electrical equipment clip for removal from deadbreak or loadbreak elbows and are constructed from a plastic polymer material that facilitates easy breakage and removal when necessary.

This embodiment of the present invention also comprises a shotgun stick ring (103) for connecting to a manipulation device such as a shotgun stick or a grip-all. The shotgun stick ring (103) is a roughly circular area of the body of sufficient strength to allow a shotgun stick or grip-all to connect to the electrical cable clip. A lineman can pick up, move, attach, detach, or perform other types of manipulation by using the shotgun stick ring (103) on the electrical equipment clip without having to de-energize the deadbreak or loadbreak elbow to which the clip is attached. Furthermore, the shotgun stick ring (103) allows for the deadbreak or loadbreak elbow to be manipulated with fewer people. Typical deadbreak or loadbreak elbow manipulation operations can require up to four individuals but with the present invention, it is possible for a single person to perform a manipulation procedure.

This embodiment of the present invention also comprises a forward baffle (106) that covers deadbreak bails or bail assemblies. The forward baffle (106) is an elongated portion of the electrical equipment clip body (100) located at one end of the electrical equipment clip. The baffle (106) covers and protects a bail or bail assembly so that no damage occurs to the bail when the electrical equipment clip is used to manipulate the deadbreak or loadbreak elbow.

This embodiment of the present invention also comprises a capacitor test point opening (107) that is an opening within the electrical equipment clip body (100) through which deadbreak or loadbreak elbow test points pass. A deadbreak or loadbreak elbow test point is generally used to indicate whether the elbow is energized, and for fault indication. The capacitor test point opening (107) allows a deadbreak or loadbreak elbow test point to remain visible and functional when the electrical equipment clip is attached.

Embodiments of the present invention conform visually to federal, state, or local specifications and compliance requirements. The color of the electrical equipment clip is a visual characteristics that must conform to the aforementioned specifications and compliance requirements. In an embodiment of the present invention, the electrical equipment clip is a bright yellow color so that it meets compliance requirements by being easy to see, and can be quickly located in dark or dimly-lit conditions.

The size of letters printed on the electrical equipment clip is another visual characteristic that must meet certain specifications and compliance requirements. In an embodiment of the present invention, all the letters, numerals, and symbols printed on the electrical equipment clip will be readable from a distance of four feet or greater. The letters, numerals and symbols that must be readable from four feet away or greater include the letters, numerals, and symbols located on the detachable information tabs (102, 105) or any letters, letters, numerals, and symbols located on the body of the electrical equipment clip (100). In certain embodiments of the present invention, the letters, numerals, and symbols printed on any identification device or lanyard attached to the electrical equipment clip by way of the lanyard ring (104) are also readable from a distance of four feet away or greater.

Embodiments of the present invention are constructed from materials that possess important properties that include, but are not be limited to, electrical non-conductivity, ultra-violet (UV) resistance, reflectivity, heat resistance, and oil resistance. Certain embodiments of the present invention possess combinations of the aforementioned properties as needed for particular applications. By way of example, an embodiment of the present invention provides an electrical equipment clip that is UV resistant, and oil resistant. Other embodiments of the present invention provide additional material properties as required for compliance, safety, or practical purposes.

An additional material property is the ability to be flexible, yet simultaneously rigid as is found in with some plastic polymers. This material property allows for the proper amount of electrical equipment clip bending or flexing, yet still allows the clip to remain attached to an electrical cable, a deadbreak elbow, or a loadbreak elbow without becoming inadvertently dislodged.

It is important to note that some embodiments of the present invention are used with components of electrical equipment that are located above ground while other embodiments of the present invention are used with components of electrical equipment that are located below ground. However, it is expected that one primary application of the present invention will be with underground cables, particularly those passing through utility vaults. Another primary application will be with deadbreak or loadbreak elbows. It is expected that by placing the present invention in underground utility vaults, manipulation of energized electrical cables will be safer, more efficient, and require fewer people. It is further expected that an indirect benefit of the present invention will be a cost-savings to electrical companies that deploy the invention.

As set forth in this description and the attached images, a new electrical equipment clip has been developed that improves upon conventional electrical equipment clips. The various embodiments of the improved electrical equipment clip described herein can be used in a wide variety of applications.

The preceding exemplary embodiments are not intended to be limiting, but are merely illustrative for the possible uses of the electrical equipment clip.

Although certain example apparatus and articles of manufacture have been described herein, the scope of coverage of this patent is not limited thereto. On the contrary, this patent covers all apparatus and articles of manufacture fairly falling within the scope of the invention either literally or under the doctrine of equivalents.

With respect to the above description then, it is to be realized that the optimum dimensional relationships for the components of the electrical equipment clip, to include variations in size, materials, shape, form, function and the manner of operation, and use, are deemed readily apparent and obvious to one skilled in the art, and all equivalent relationships to those illustrated in the images and described in the specification are intended to be encompassed by the electrical equipment clip.

Directional terms such as “front”, “back”, “in”, “out”, “downward”, “upper”, “lower”, “top”, “bottom”, “lateral”, “vertical” and the like have been used in the description. These terms are applicable to the embodiments shown and described in conjunction with the images. These terms are merely used for the purpose of description in connection with the images and do not necessarily apply to the positions in which the electrical equipment clip may be used.

Therefore, the foregoing is considered as illustrative only of the principles of the electrical equipment clip. Further, since numerous modifications and changes will readily occur to those skilled in the art, it is not desired to limit the electrical equipment clip to the exact construction and operation shown and described, and accordingly, all suitable modifications and equivalents may be resorted to, falling within the scope of the electrical equipment clip. While the above description describes various embodiments of the present invention, it will be clear that the present invention may be otherwise easily adapted to fit any configuration where an electrical equipment clip is desired or required.

As various changes could be made in the above constructions without departing from the scope of the invention, it is intended that all matter contained in the above description or shown in the accompanying images shall be interpreted as illustrative and not in a limiting sense.

What is claimed is:

1. An apparatus comprising:
an electrical equipment clip body that wraps partially around electrical equipment;
shaped flanges extending from the electrical equipment clip body that grip the electrical equipment so that the apparatus remains firmly in place and does not inadvertently move when the apparatus is used to manipulate the electrical equipment; an area on the electrical equipment body that allows for the attachment of a shotgun stick or a grip-all;
and the apparatus allowing a lineman to manipulate the electrical equipment using the shotgun stick or grip-all.

2. The apparatus of claim 1, further comprising detachable information tabs that indicate information about the electrical equipment to which the apparatus is attached.

3. The apparatus of claim 2, wherein the detachable information tabs indicate the phase of an electrical cable.

4. The apparatus of claim 2, wherein the detachable information tabs indicate the voltage of an electrical cable.

5. The apparatus of claim 1, further comprising a lanyard ring attached to the electrical equipment clip body that provides a connection point for compliance-required identification devices, destination tags, or GPS tags.

6. The apparatus of claim 1, wherein the apparatus is constructed from an oil and heat resistant polymer.

7. The apparatus of claim 6, wherein the polymer is highly visible, reflective, or luminescent.

8. An electrical equipment clip that attaches to an electrical cable comprising:
an electrical equipment clip body that wraps partially around the electrical cable; shaped flanges extending from the electrical equipment clip body that grip the electrical cable so that the electrical equipment clip remains firmly in place and does not inadvertently move when the electrical equipment clip is used to manipulate the electrical cable; a shotgun stick ring that allows for the attachment of a shotgun stick or a grip-all to the electrical equipment clip; a lanyard ring that allows for the attachment of identification devices or lanyards to the electrical equipment clip; phase identification tabs that contain information about the phase of the electrical cable; voltage identification tabs that contain information about the voltage of the electrical cable; and the electrical equipment clip allowing a lineman to manipulate the electrical cable using the shotgun stick or the grip-all without having to de-energize the cable.

9. The electrical equipment clip of claim 8, wherein the shaped flanges are able to be broken off of the electrical equipment clip body so that the electrical equipment clip can be removed from the electrical cable.

10. The electrical equipment clip of claim 8, wherein the identification devices include destination tagging devices or GPS tagging devices.

11. The electrical equipment clip of claim 8, wherein one or more of the voltage identification tabs can be broken off of the electrical equipment clip so that a remaining voltage identification tab properly indicates the voltage of the electrical cable.

12. The electrical equipment clip of claim 8, wherein one or more of the phase identification tabs can be broken off of the electrical equipment clip so that a remaining phase identification tab properly indicates the phase of the electrical cable.

13. The electrical equipment clip of claim 8, wherein an oil and heat resistant polymer is used to form the electrical equipment clip.

14. An electrical equipment clip that attaches to a deadbreak or loadbreak elbow comprising:
an electrical equipment clip body that wraps partially around the deadbreak or loadbreak elbow; shaped flanges extending from the electrical equipment clip body that grip the deadbreak or loadbreak elbow so that the electrical equipment clip remains firmly in place and does not inadvertently move when the electrical equipment clip is used to manipulate the deadbreak or loadbreak elbow; a shotgun stick ring that allows for the attachment of a shotgun stick or a grip-all to the electrical equipment clip; a forward baffle that covers a deadbreak bail or bail assembly when the electrical equipment clip is attached to the deadbreak; a capacitor test point opening that is an opening within the electrical equipment clip body through which a deadbreak or loadbreak elbow test point passes when the electrical cable clip is attached to the deadbreak or loadbreak elbow; and
the electrical equipment clip allowing a lineman to manipulate the deadbreak or loadbreak elbow using the shotgun stick or the grip-all.

15. The electrical equipment clip of claim 14, wherein the electrical equipment clip body is flexible, yet simultaneously rigid so that the electrical cable clip can bend or flex, yet still remain attached to the deadbreak or loadbreak elbow without becoming inadvertently dislodged.

16. The electrical equipment clip of claim 14, wherein the shaped flanges can be removed from the electrical equipment clip by breaking them off so that the electrical equipment clip can be detached from the loadbreak or deadbreak elbow.

17. The electrical equipment clip of claim 14, wherein the deadbreak or loadbreak elbow to which the electrical cable clip attaches is in a utility vault.

18. The electrical equipment clip of claim 14, wherein a highly visible, reflective, or luminescent material is used to form the electrical cable clip.

19. The electrical equipment clip of claim 14, wherein all lettering, numerals, or symbols on the electrical cable clip are readable from a distance of four feet or greater.

20. The electrical equipment clip of claim 14, wherein the electrical cable clip allows for the attachment of identification devices to meet compliance requirements.
